(19) United States
(12) Patent Application Publication
(10) Pub. No.: US 2026/0359005 A1
(43) Pub. Date: Nov. 12, 2026

(54) APPARATUS AND METHOD FOR MAXIMUM EXPONENT-BASED MATRIX MULTIPLICATION ENGINE

(71) Applicant: Intel Products IP LLC, Santa Clara, CA (US)

(72) Inventors: Chuanjun Zhang, Devon, PA (US); Matthew Adiletta, Bolton, MA (US); Simon C. Steely, JR., Hudson, NH (US)

(73) Assignee: Intel Products IP LLC, Santa Clara, CA (US)

(21) Appl. No.: 19/722,525

(22) Filed: Jun. 26, 2026

(51) Int. Cl. G06F 7/22; G06F 5/01; G06F 7/50; G06F 7/523; G06F 7/544; G06F 9/50

(52) U.S. Cl. CPC G06F 7/22; G06F 5/01; G06F 7/50; G06F 7/523; G06F 7/5443; G06F 9/5027

(57) ABSTRACT

Apparatus and method for maximum exponent-based matrix multiplication. For example, an apparatus comprises: one or more memories to store a plurality of activation data elements and a plurality of weight data elements; and accelerator circuitry coupled to the one or more memories, the accelerator circuitry comprising: precomputation circuitry to determine a global maximum exponent based on a maximum activation exponent of the plurality of activation data elements and a maximum weight exponent of the plurality of weight data elements; multiply-accumulate (MAC) circuitry to: align mantissa products of the activation data elements and the weight data elements based on the global maximum exponent to produce aligned mantissa products; and accumulate the aligned mantissa products to generate an output result.

### BACKGROUND

### Field of the Disclosure

This disclosure relates generally to the field of microprocessors. More particularly, the invention relates to an apparatus and method for maximum exponent-based matrix multiplication engine.

### Description of the Related Art

Current AI training and inferencing engines are designed to natively process various types and sizes of floating point data elements, including 8-bit floating point (FP8), 16-bit floating point (BF16, FP16) Tensor Float 32 (TF32) dot-products are widely used in both AI training and inference engine design.

Optimizing dot-product circuitry for efficient and high performance matrix multiplications is of paramount importance for LLM implementations. A conventional technique to accelerate low-precision floating-point (FP) computations, particularly with 8-bit and 16-bit formats, is the Block-Normalized Adder (BNA)-based design, which diverges from a naive, sequential “multiply and accumulate” approach. Instead, it processes a block of multiple low-precision element pairs in parallel within a single, deeply pipelined MAC unit. The core innovation lies in its handling of the floating-point arithmetic. In particular, it defers normalization until a block of partial products has been computed, thereby amortizing the cost of expensive normalization operations.

The operational flow of BNA design can be broken down into the following stages:

Parallel Exponent Summation and Mantissa Multiplication: For a block of N element pairs (e.g., N=4, 8, or 16), the exponents of each (Aᵢ, Bᵢ) pair are summed in parallel. Concurrently, the signed magnitude mantissa is multiplied to generate mantissa products.

Block-Wide Alignment: A critical step for correct summation is aligning all mantissa products to a common exponent base. This is achieved by first identifying the maximum value among the N summed exponents. Each product's exponent is then subtracted from this maximum exponent, yielding a per-product shift value.

Convert and Shift: The intermediate mantissa products are converted into 2's complement representation, which is necessary for a correct signed summation then right-shifted according to their respective shift values to align the binary points with correct rounding based on the accumulator width.

Block Accumulation: All N converted, shifted, and rounded mantissa products are summed together into a single, wider intermediate result (e.g., into an accumulator). This step effectively computes the dot product for the entire block in one consolidated operation.

Final Normalization: The accumulated result is then normalized according to standard floating-point conventions, producing a final high-precision output (typically FP32) that is ready to be fed back into the accumulator for the next block or written to memory.

### BRIEF DESCRIPTION OF THE DRAWINGS

A better understanding of the present invention can be obtained from the following detailed description in conjunction with the following drawings, in which:

FIG. 1 illustrates an example block normalized adder based FP dot product circuit.

FIG. 2 illustrates a maximum exponent-based matrix multiplication engine in accordance with embodiments of this disclosure.

FIGS. 3A-B illustrate a method implemented a maximum exponent-based matrix multiplication engine in accordance with embodiments of this disclosure.

FIGS. 4A-B illustrate contrasts a computational flow diagrams of a conventional, block-wise maximum exponent-based Multiply-Accumulate (MAC) operation with one embodiment of a global maximum exponent (GME)-based MAC operation.

FIG. 5A illustrates an example embodiment of a MAC circuit block for processing 8-bit floating-point activation (A) and weight (W) matrix data elements.

FIG. 5B illustrates an example embodiment of a MAC circuit block for processing 16-bit floating-point A and W matrix data elements.

FIGS. 6A-B illustrate embodiments of a methodology and the corresponding hardware topology for distributing and reusing global maximum exponent parameters across a matrix multiplication engine.

FIGS. 7A-D illustrate empirical validation data, error analyses, and precision sweep results used to benchmark the performance of the global maximum exponent-based architecture against conventional baselines.

### DETAILED DESCRIPTION

Embodiments of this disclosure remove the max exponent computation from the MAC unit and perform estimation to find the max exponent, significantly reducing the area and power consumption for AI processing. The disclosed embodiments implement techniques for optimizing floating-point matrix multiplications, including global maximum exponent utilization. Instead of computing maximum exponents on a per-block basis, these embodiments determine a global maximum exponent derived from multiple blocks to perform dot-product computations.

In these embodiments, the maximum exponent may be estimated from the two input operands (weights and activations) rather than being computed directly through conventional techniques. This estimation reduces computational complexity of the maximum exponent by an order of magnitude.

These embodiments are especially beneficial in LLM training and inference implementations, which rely on source values such as FP4, FP8, FP16, BF16 and TF32. In addition, embodiments of this disclosure consume significantly lower power than current processor architectures.

The disclosed embodiments provide a highly optimized hardware solution for executing 8-bit and 16-bit floating-point (e.g., FP8, FP16, BF16, and TF32) dot products, which are critical for Large Language Model (LLM) training and inference. To solve the power and area bottlenecks of conventional sequential multiply-and-accumulate units, these embodiments fundamentally shift from block-wise normalization to a global optimization model. It eliminates redundant per-block exponent calculations by employing a single global maximum exponent derived from multiple blocks, and computationally simplifies the max exponent derivation by estimating it directly from the input operands. This approach reduces computational complexity, drastically reducing the need for costly FP32 normalizations, and enables significant area and power savings for performing AI operations, such as matrix multiplications.

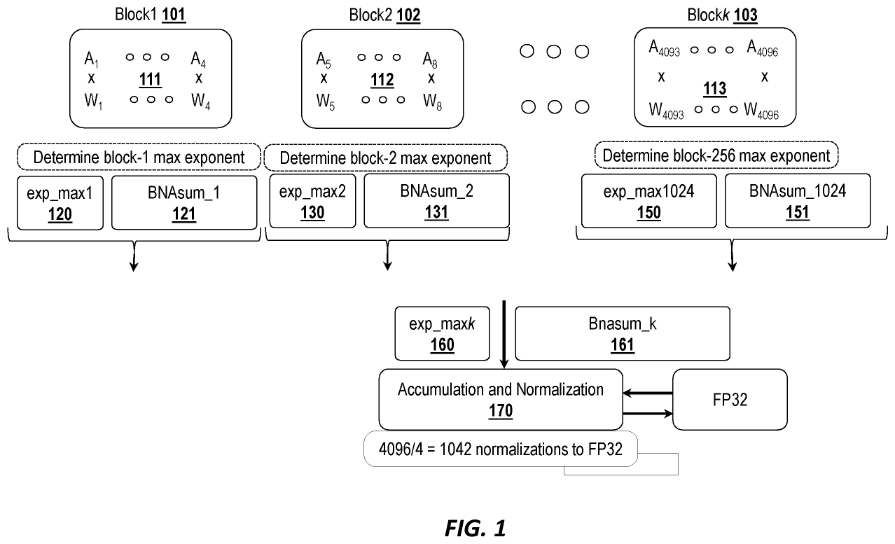

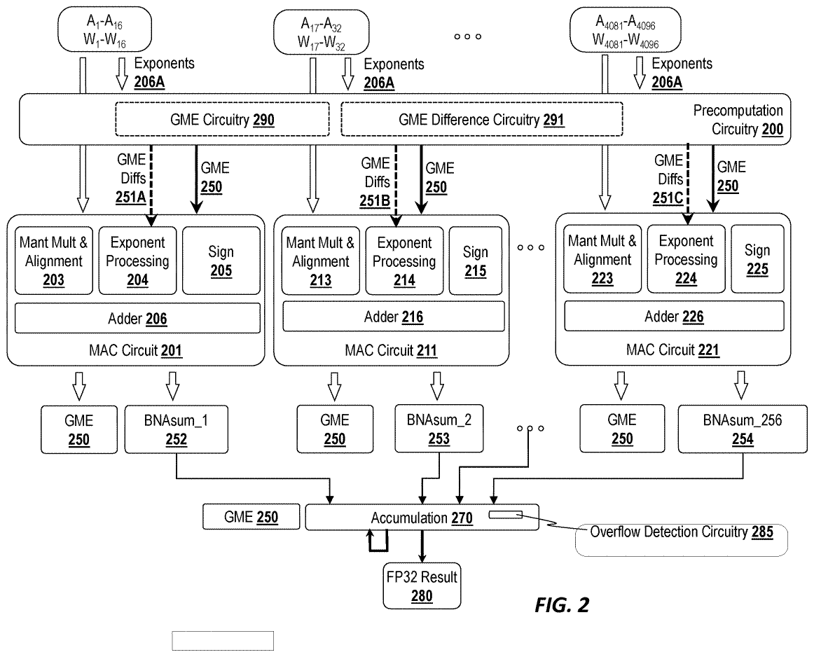

FIG. 1 illustrates an example of block-normalized adder-based FP dot-product circuitry comprising a plurality of parallel multiplication units 101-103, each of which has a block size of 4 to perform four parallel multiplications. In particular each activation value of an activation matrix (A₁-A₄₀₉₆ is multiplied by a corresponding weight value of a weight matrix (W₁-W₄₀₉₆, with each block 101-103 performing four of these multiplications.

Each BNA_sum block (e.g., BNA_sum1 121, BNAsum2 131, and BNAsum_1024 151) generates the sum of the products of its corresponding block. For example, BNAsum_1 121 sums the products generated by block 1 101 (A₁×W₁+A₂×W₂+A₃×W₃+A₄×W₄). The sums from each of the BNAsum_n blocks are accumulated by accumulation and normalization logic 170.

For each independent computational block 101-103, a local maximum exponent is determined, yielding per-block maximum exponents such as exp_max1 120 for block 101, exp_max2 130 for block 102, and exp_max1024 150 for block 103. The exp_maxk block 160 acts as a generic variable or placeholder representing the maximum exponent of the k^{th} block and the BNAsum_k 161 represents the corresponding sum of the products, both of which are provided to accumulation and normalization logic 170.

As the hardware iterates through the computations, exp_maxk sequentially takes on the value of each specific block's maximum exponent (e.g., exp_max1, exp_max2, . . . , exp_max1024, etc.) so that it can be fed, alongside its corresponding mantissa sum (Bnasum_k) 161, into the accumulation and normalization circuitry 170 which periodically outputs an FP32 normalized values.

FIG. 2 includes a global execution model in accordance with some embodiments of this disclosure, including precomputation circuitry 200 for determining a global maximum exponent (GME) 250 to be used by all MAC circuit blocks 201, 211, 221 (only three of which are shown for simplicity) and a plurality of GME difference values 251A-C, each of which is unique to a specific MAC circuit block. In the illustrated embodiment, each MAC circuit block 201, 211, 221 operates on a group of 16 activation (A) data elements and 16 corresponding weight (W) data elements of FP8 and/or BF8 data elements. However, the underlying principles of this disclosure are not limited to any particular data input types or any particular size of the MAC circuit blocks. For example, in another embodiment described below, each MAC circuit block 201, 211, 221 operates on a group of eight 16-bit A and eight 16-bit W data elements (e.g., BF16 and/or FP16 data elements).

Returning to the embodiment in FIG. 2, rather than calculating individual maximum exponents for each distinct block (which forces the system to execute 1,024 separate normalizations), global maximum exponent circuitry 290 determines a single global maximum exponent (GME) 250 to be used across all products generated by the parallel MAC circuit blocks 201, 211, 221. In addition, GME difference circuitry 291 generates GME difference values 251A-C corresponding to each block of 16 A data elements and 16 W data elements. Once the GME 250 is determined, each MAC circuit block 201, 211, and 221 aligns its mantissa products using this shared exponent.

The illustrated embodiment operates on input blocks comprising of 16 FP8 A data elements and 16 FP8 W data elements. Regardless of the data element size, the GME circuitry 290 determines a global maximum exponent (GME) 250 across all blocks of input values to optimize low-precision floating-point dot products, such as FP8, BF8, BF4, FP16, and BF16. Unlike conventional block-wise architectures that compute and apply independent maximum exponents for each localized processing block, the illustrated architecture amortizes normalization costs by aligning all intermediate block sums uniformly, thereby requiring only a single normalization to FP32 triggered by overflow detection.

The input data blocks comprise corresponding pairs of activation (A) data elements and weight (W) data elements divided into processing blocks. In an exemplary FP8 embodiment, these are processed in blocks of 16 element pairs, denoted as A₁-A₁₆ and W₁-W₁₆ for the first block, extending up to A₄₀₈₁-A₄₀₉₆ and W₄₀₈₁-W₄₀₉₆ for the 256th block. The Exponents 206A from the A and W input vectors are parsed and routed directly to the precomputation circuitry 200. The GME circuitry 290 then computes the GME 250 not by executing parallel block sums, but by independently evaluating the maximum exponent of the activations and the maximum exponent of the weights across the array, and estimating the total max exponent. In particular, the GME circuitry 290 estimates the maximum exponent based on the known condition:

max(A[i]+W[i])≤max(A[i])+max(W[i])).

Thus, rather than adding the exponents for every single A and W pair first, and then comparing all of those sums against each other to find the true maximum, the GME circuitry 290 determines a safe upper bound comprising the sum of the maximum A exponent of all A exponents and the maximum W exponent of all W exponents, which is guaranteed to be large enough to hold the largest possible value. In these embodiments, GME circuitry 290 individually scans the Activation vector and the Weight vector to find the single largest exponents, max(A[i]) and max(W[i]), respectively.

To optimize downstream multiply-accumulate operations, the GME difference determination circuitry 291 subtracts the respective activation exponents from the GME 250 to generate precomputed reusable shift values for each individual MAC circuit block 201, 211, and 221, shown as corresponding GME diff values 251A, 251B, and 251C.

Each of the plurality of MAC circuit blocks 201, 211, 221 includes corresponding exponent processing logic 204, 214, and 224, which receives the corresponding GME diff value 251A and subtracts the incoming weight exponent to finalize the right-shift alignment value. Corresponding sign logic 205, 215, and 225 computes the product signs via XOR operations, while mantissa multiplication and alignment logic 203, 213, and 223 multiplies the operands, converts them to 2′s complement, and executes a right-shift with round-toward-zero (RTZ) based on the shift value provided by the exponent processing logic 204, 214, and 224.

Thus, by isolating the A and W exponent maximums, the MAC circuit blocks 201, 211, 221 can reuse the max(A[i]) value across an entire row of matrix operations, and the max(W[i]) value across an entire column, dropping the computational overhead by an order of magnitude. If the estimated exponent is artificially larger than the real one, the corresponding MAC circuit block 201, 211, 221 shifts the mantissas a few extra binary places to the right during alignment.

To prevent those values from falling off the edge and losing precision, the mantissa multipliers & alignment units 203, 213, and 223, right-shift to align with the estimated GME 250 before any local addition is performed by the corresponding adders 206, 216, and 226, respectively. To prevent the least significant bits from “falling off” and being permanently lost to truncation, the internal local adders 206, 216, 226 are configured to be wider to catch those extra bits (e.g., 17-way adders in some embodiments described herein).

Additionally, since the local MAC circuit blocks 201, 211, and 221 output wider, more precise intermediate sums, BNAsums_1 252, BNAsum_2 253, and BNAsum_256 254, respectively, the final accumulation circuit 270 is configured to be correspondingly wider to successfully receive, store, and tally those extended mantissas prior to the final normalization step to FP32.

The respective block sums, BNAsum_1 through BNAsum_256 (only three of which are illustrated for simplicity) are passed to the central accumulation circuitry 270. Because all mantissas were uniformly aligned relative to the shared GME 250, the accumulation block 270 can sum the values natively without requiring further relative shifting. The accumulation circuitry 270 may be implemented as a sequential accumulator tracking a running total iteratively and/or as a parallel adder tree structure to process multiple sets of BNAsums simultaneously. The level of parallel and/or sequential accumulating may vary in different implementations.

In some embodiments, the accumulation circuitry 270 includes overflow detection circuitry 285 to monitor the accumulator width (which may include extra bits, such as 5 extra bits, to preserve precision). Upon detection of an overflow condition by the overflow detection circuitry 285, or upon completion of the accumulate operations, the accumulator 270 normalizes the aggregated result into an FP32 Result 280.

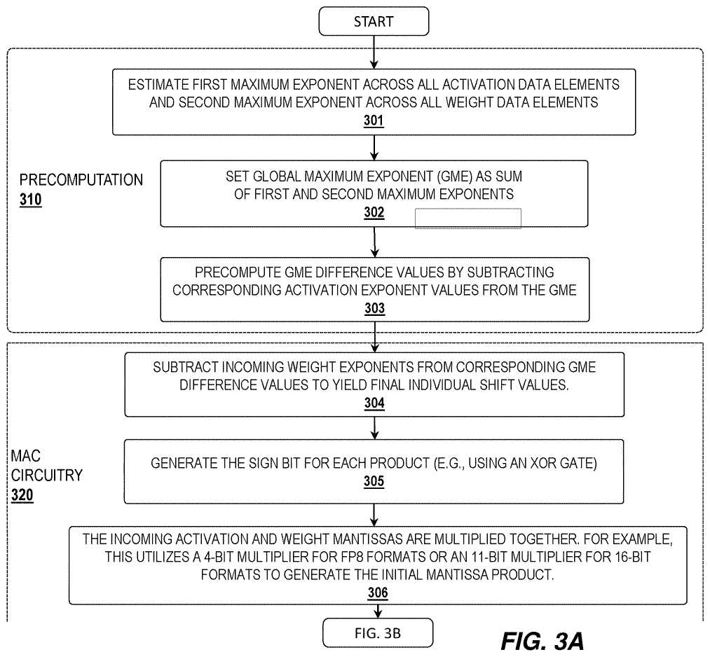

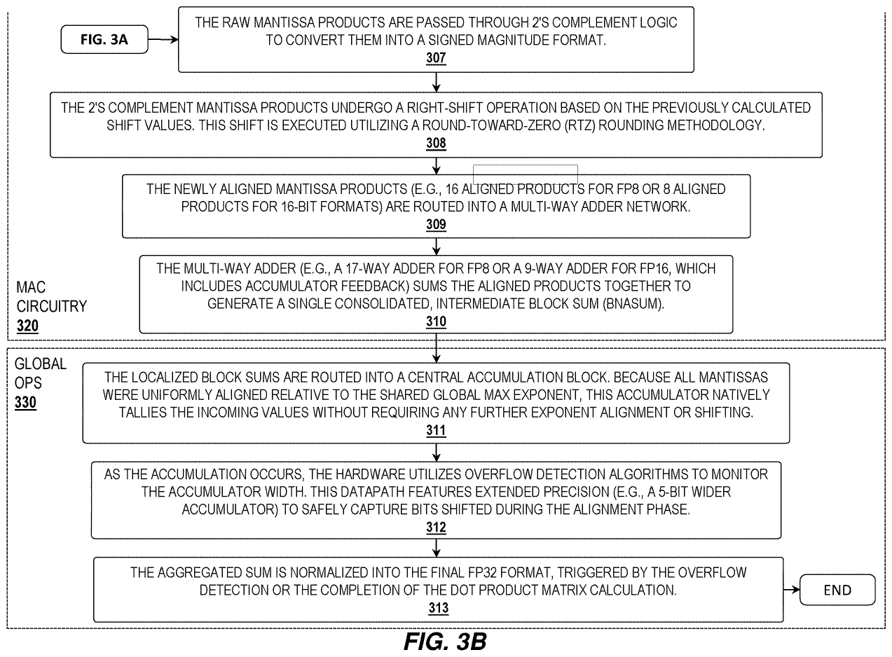

FIGS. 3A-B illustrate a sequence of operations in accordance with some embodiments of this disclosure. This operational sequence may be performed on the architectures described herein but is not limited to any particular processor or system architecture. The operational flow is divided into three primary phases: Precomputation 310, MAC Circuitry operations 320, and Global Operations 330.

During the precomputation phase 310, the system first estimates a first maximum exponent across all activation data elements and a second maximum exponent across all weight data elements at 301. At 302, the global maximum exponent (GME) is set as the sum of these first and second maximum exponents. Subsequently, at 303, the system precomputes GME difference values by subtracting corresponding activation exponent values from the GME. These precomputed values can be highly reused across iterations as described herein.

Within the MAC circuitry phase 320, the hardware executes operations for individual data pairs. At 304, incoming weight exponents are subtracted from corresponding GME difference values to yield final individual shift values. Concurrently, the sign bit for each product is generated using an XOR gate at 305. At 306, the incoming activation and weight mantissas are multiplied together (e.g., utilizing a 4-bit multiplier for FP8 formats or an 11-bit multiplier for 16-bit formats) to generate the initial mantissa product. These raw mantissa products are passed through 2's complement logic to convert them into a signed magnitude format at 307. At 308, the 2's complement mantissa products undergo a right-shift operation based on the previously calculated shift values, executing a Round-Toward-Zero (RTZ) rounding methodology. The newly aligned mantissa products (e.g., 16 aligned products for FP8 or 8 aligned products for 16-bit formats) are routed into a multi-way adder network at 309. At 310, the multi-way adder (e.g., a 17-way adder for FP8 or a 9-way adder for FP16, which includes accumulator feedback) sums the aligned products together to generate a single consolidated, intermediate block sum (BNAsum).

During the global operations phase 330, the localized block sums are routed into a central accumulation block at 311. Because all mantissas were uniformly aligned relative to the shared GME, this accumulator natively tallies the incoming values without requiring further exponent alignment or shifting. At 312, the hardware utilizes overflow detection algorithms to monitor the accumulator width. This datapath features extended precision (e.g., a 5-bit wider accumulator) to safely capture bits shifted during the alignment phase. Finally, at 313, triggered by overflow detection or the completion of the dot product matrix calculation, the aggregated sum is normalized into the final FP32 format.

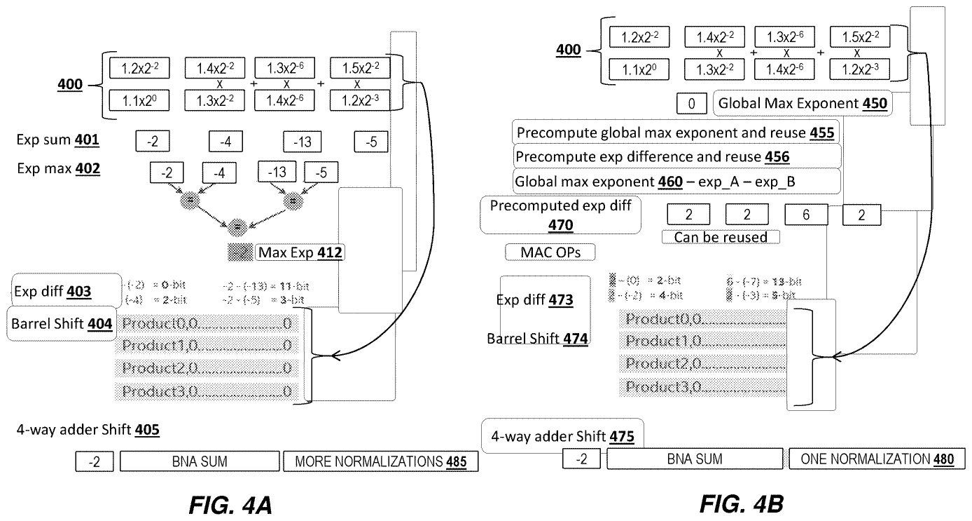

FIG. 4A illustrates a computational flow diagram of a conventional, block-wise maximum exponent-based Multiply-Accumulate (MAC) operation. This baseline architecture processes floating-point mathematics by treating each small block of data as an isolated alignment problem. The sequence utilizes an example block of four activation-weight pairs 400. The components and operations in FIG. 4A include exponent sum 401, the initial MAC operation where the hardware calculates the sum of the exponents for each individual data pair within the block, yielding sums of −2, −4, −13, and −5 and exponent max 402, the comparison logic that evaluates the parallel outputs from the exponent sum 401 stage to find the highest numerical value among them.

A localized maximum exponent is determined by the exp max logic 402, which is −2 in the illustrated example. This value dictates the alignment target exclusively for this specific localized block. Exp diff 403 comprises subtraction logic that calculates the difference between the local max exp 412 and each individual exp sum 401. This outputs the exact bit-shift requirements (0-bit, 2-bit, 11-bit, and 3-bit) needed to properly align the mantissas.

The barrel shift stage 404 comprises the hardware shifting logic that receives the calculated shift values from exp diff 403 and right-shifts the corresponding mantissa products (Product0,0 through Product3,0) to align their binary points. A 4-way adder shift 405 comprises a localized multi-way adder that sums the aligned mantissa products together to produce the intermediate BNA Sum.

Because the max exp 412 is isolated to this single 4-element block, the resulting BNA Sum cannot be natively accumulated with sums from other parallel blocks. This architecture dictates a frequent, repetitive set of normalizations 485 to normalize intermediate results to FP32, creating a performance and power bottleneck.

FIG. 4B illustrates a computational flow diagram of one embodiment of the global maximum exponent (GME)-based MAC operation, utilizing the same example data inputs 400. By establishing a global baseline prior to multiplication, the architecture offloads complex logic from the MAC unit and eliminates redundant normalizations.

In these embodiments, the global max exponent 450 comprises a single, global target exponent (e.g., 0) derived for the entire computation array rather than just the local block.

Precompute GME and reuse 455 and precompute exponent difference and reuse 456 represent the operations performed to precompute the global max exponent and the exponent difference and reuse them as described herein. As mentioned, the maximum exponent is estimated by independently determining the maximum activation exponent and the maximum weight exponent across the array, and summing them.

The operations global max exponent 460—exp_A-exp_B are used by the illustrated embodiment to determine the final mantissa alignment shift. To optimize these operations the precomputed exp diff 470 is predetermined before the MAC operations begin (e.g., GME—exp_A). Because an activation row is multiplied against multiple weight columns, these resulting shift values (2, 2, 6, 2) can be reused across iterations to save computational cycles. The streamlined subtraction logic located inside the MAC unit, exp diff 473, takes the predetermined exp diff 470 and subtracts the incoming weight exponent (exp_B) to yield the final, precise individual right-shifts (2-bit, 4-bit, 13-bit, 5-bit) for the pairs.

The barrel shift circuitry 474 comprises the shifting logic that receives the shift values from exp diff 473 and right-shifts the mantissa products to align their binary points prior to addition. A 4-way adder Shift 475 comprises a multi-way adder that sums the properly aligned mantissa products to produce the intermediate BNA Sum.

Because the intermediate BNA Sum produced by the 4-way adder Shift 475 (and all other parallel blocks in the operation) is aligned to the exact same GME 450, the values can be aggregated natively in a central accumulator without relative shifting. Consequently, the system only executes a single FP32 normalization 480 triggered by overflow detection, thereby bypassing the normalization penalty seen in the conventional design.

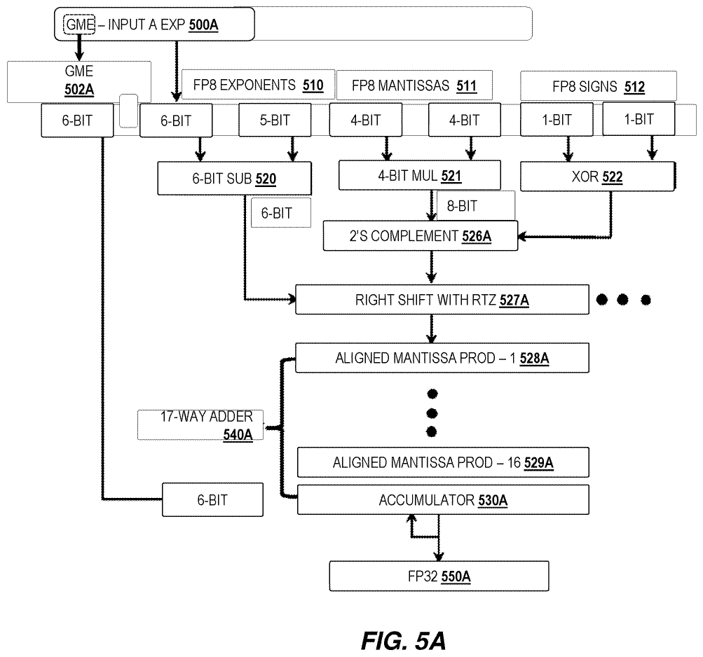

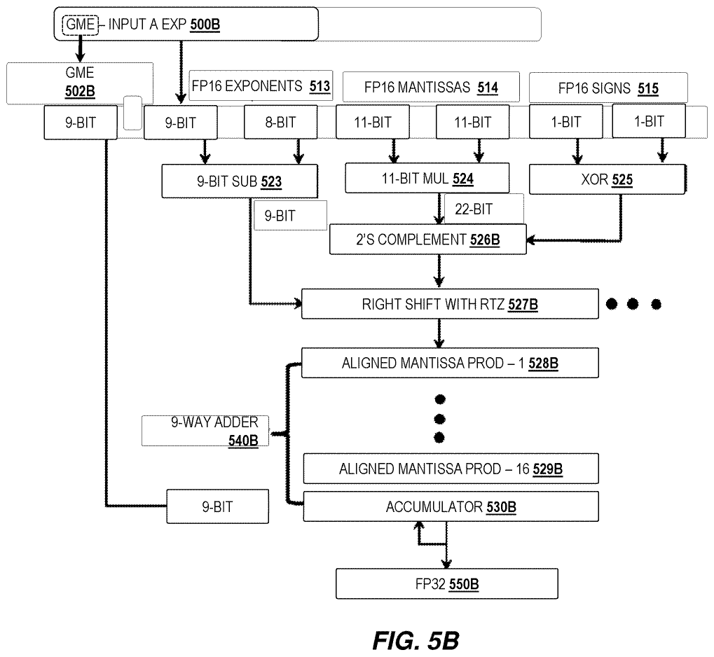

FIG. 5A illustrates an example embodiment of a MAC circuit block for processing 8-bit floating-point (e.g., FP8 or BF8) activation (A) and weight (W) matrix data elements and FIG. 5B illustrates an example MAC circuit block for processing 16-bit floating-point (e.g., FP16 or BF16) A and W matrix data elements. In some embodiments, the illustrated circuitry is integrated within the MAC circuit blocks 201, 211, 221 described above with respect to FIG. 2.

In FIG. 5A the max exponent-based dot product MAC circuit block which, unlike conventional block-wise MAC designs, incorporates an explicit input pathway for a precomputed exponent difference, GME—input A Exp 500A, as well as a 6-bit input for the GME 502A itself. The circuitry is configured to receive parallel data streams comprising 6-bit and 5-bit FP8 Exponents 510, 4-bit FP8 mantissas 511, and 1-bit FP8 Signs 512. To process these inputs, the architecture divides the arithmetic workload:

Exponent Processing: A 6-bit subtractor (SUB) 520 calculates the final mantissa right-shift value by subtracting the incoming weight exponent from the precomputed difference parameter 500A.

Mantissa Multiplication: Concurrently, a 4-bit multiplier (MUL) 521 computes the product of the incoming 4-bit mantissas, generating an 8-bit output.

Sign Processing: An XOR logic gate 522 evaluates the 1-bit FP8 sign 512 to resolve the final sign of the resulting product.

The 8-bit mantissa product is subsequently translated into a signed magnitude via 2's Complement circuitry 526A, utilizing the sign determined by the XOR gate 522. The signed product is then passed to a right shift with Round-Toward-Zero (RTZ) unit 527A, which aligns the binary point of the product based on the shift value outputted by the 6-bit SUB 520, employing a RTZ methodology.

This alignment phase yields a plurality of aligned products, shown ranging from aligned mantissa prod-1 528A through aligned mantissa prod-16 529A. These aligned products are routed into a 17-way adder 540A which sums the 16 aligned mantissa products alongside a 6-bit feedback loop provided by an accumulator circuit 530A. The aggregated sum is held within the accumulator 530A before being normalized and outputted into a final FP32 550A format.

FIG. 5B illustrates a corresponding hardware architecture scaled and configured for 16-bit (e.g., FP16, BF16) GME-based dot product MAC operations. Mirroring the high level logical datapath of FIG. 5A, this scaled architecture receives a precomputed GME-input A Exp 500B parameter and a corresponding 9-bit GME 502B.

The 16-bit datapath processes incoming 9-bit and 8-bit FP16 Exponents 513, 11-bit FP16 mantissas 514, and a corresponding 1-bit FP16 sign value 515. The parallel processing pathways are scaled as follows:

Exponent Processing: A 9-bit SUB 523 calculates the necessary alignment shift utilizing the precomputed 500B parameter.

Mantissa Multiplication: An 11-bit MUL 524 multiplies the incoming mantissas to yield a wider 22-bit product.

Sign Processing: An XOR logic gate 525 evaluates the input signs 515 to determine the resultant product sign.

Following magnitude conversion via 2's Complement 526B circuitry, the 22-bit product is aligned by a Right shift with RTZ unit 527B. The resulting outputs, shown extending from aligned mantissa prod-1 528B through aligned mantissa prod-16 529B, are fed into a 9-way adder 540B which natively aggregates the aligned products along with a 9-bit feedback feed from an accumulator 530B. Finally, the completed sum stored in the accumulator 530B undergoes normalization to produce the high-precision FP32 550B output.

Thus, the GME 250 and GME Diff 251A described with respect to FIG. 2 is input to the MAC circuitry in FIGS. 5A-B to enable the highly efficient MAC operations described herein. FIGS. 5A and 5B provides additional details related to the circuitry used to implement the functional blocks for mantissa multiplication & alignment 203, 213, 223, exponent processing 204, 214, 224, and sign 205, 215, 225 functions described with respect to FIG. 2. In particular, using MAC circuit block 201 as a representative example, the sign logic 205 may be physically realized by the XOR logic gates 522, 525 in FIGS. 5A-B, which evaluate the incoming 1-bit sign values. The exponent processing 204 may be implemented by the 6-bit SUB 520 (for FP8) or 9-bit SUB 523 (for FP16) in FIGS. 5A-B. These subtractors take the GME Diff and subtract the incoming weight exponents to find the final shift values.

The mantissa multiplication & alignment circuitry 203 may be implemented via a sequence of three distinct hardware components in FIGS. 5A-B: the Multiplier 521/524, the 2's Complement logic 526A/B, and the right shift with RTZ unit 527A/B.

The intermediate block sum BNAsum_1 252 output by the MAC circuit block 201 is sent to the central accumulation 270 block. FIGS. 5A-B illustrate an example embodiment of an adder network used to generate that sum, including the 17-way adder 540A (or 9-way adder 540B) which aggregates the parallel aligned mantissa products. The resulting sum is caught by the accumulator 530A-B, representing the localized storage/accumulation datapath that ultimately feeds the final FP32 550A-B normalization output.

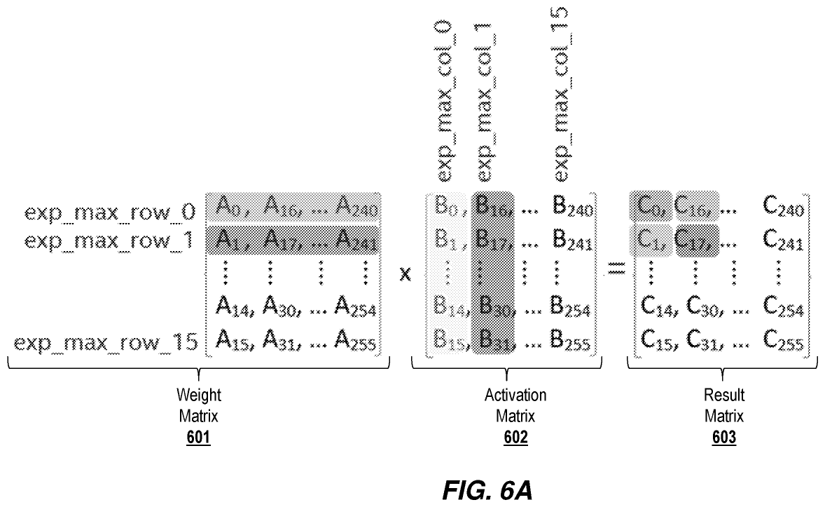

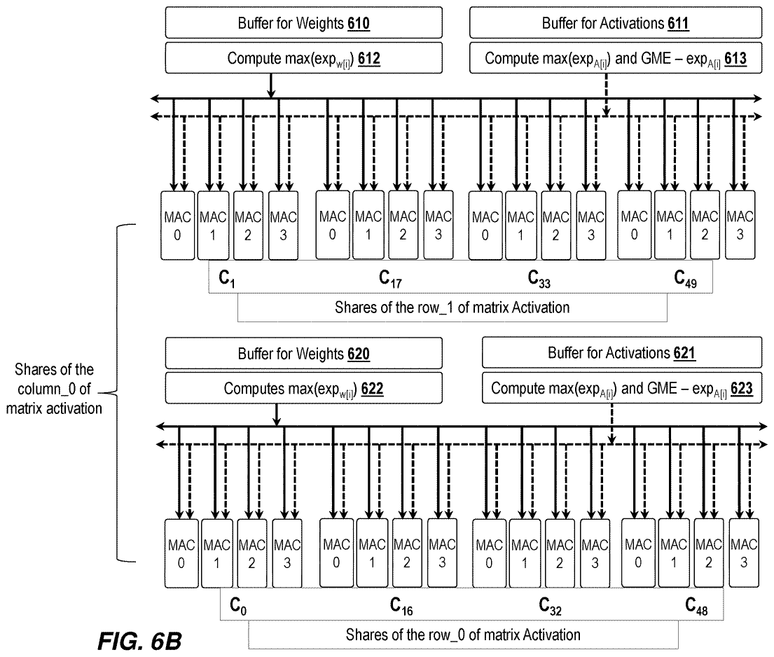

FIGS. 6A and 6B illustrate embodiments of a methodology and the corresponding hardware topology, respectively, for distributing and reusing global maximum exponent parameters across a matrix multiplication engine.

FIG. 6A depicts a logical representation of a matrix multiplication operation where an activation matrix 602 is multiplied by a weight matrix 601 to produce a result matrix 603. To optimize exponent alignment processing, the system extracts a single maximum exponent for each row of the activation matrix 602 (e.g., exp_max_row_0, exp_max_row_1, exp_max_row_15) and a single maximum exponent for each column of the weight matrix 601 (e.g., exp_max_col_0, exp_max_col_1, exp_max_col_15).

When calculating the dot product for a specific output element in the result matrix 603, the architecture combines the corresponding row and column maximums. For example, generating elements C₀, C₁₆, and C₂₄₀ all utilize the exact same exp_max_row_0 parameter from the Activation Matrix 602. This algorithmic sharing mechanism drastically reduces the volume of maximum exponent comparison operations required by the system, lowering the algorithmic complexity from O(n³) operations characteristic of conventional methods down to O(n²) operations.

FIG. 6B illustrates an example physical hardware execution topology corresponding to the logical operations of FIG. 6A. The architecture comprises data storage elements including buffers for weights 610 and 620, and buffers for activations 611 and 621. These buffers include or are coupled to precomputation logic circuitry.

Specifically, the logic 612 and 622 coupled to the weight buffers 610 and 620 is configured to compute the maximum exponent of the incoming weights. Concurrently, the logic 613 and 623 coupled to the activation buffers 611 and 621 computes the maximum exponent of the incoming activations and calculates a precomputed exponent difference (the global max exponent minus the individual activation exponent).

The precomputed alignment parameters and buffered data are broadcast over shared communication buses to a plurality of Multiply-Accumulate (MAC) arrays (e.g., MAC0, MAC1, MAC2, MAC3). The hardware routing enables multiple MAC arrays to simultaneously share data elements. For instance, the MAC arrays calculating output elements C1, C17, C33, and C49 physically share row_1 of the activation matrix via a common bus. Similarly, the MAC arrays calculating output elements C0, C16, C32, and C48 physically share col_0 of the weight matrix.

Consequently, FIG. 6A highlights the efficiency of the embodiments of this disclosure. For example, by demonstrating exactly how exponent maximums are extracted and crossed across rows and columns, it provides the technical support for reducing the algorithmic complexity from O(n³) to O(n²) of matrix mathematics.

FIG. 6B demonstrates how the operational improvements from FIG. 6A can be translated into a tangible silicon layout with specific buffers, logic blocks, and shared data buses, illustrating how the theoretical data reuse is practically executed via a shared hardware bus topology.

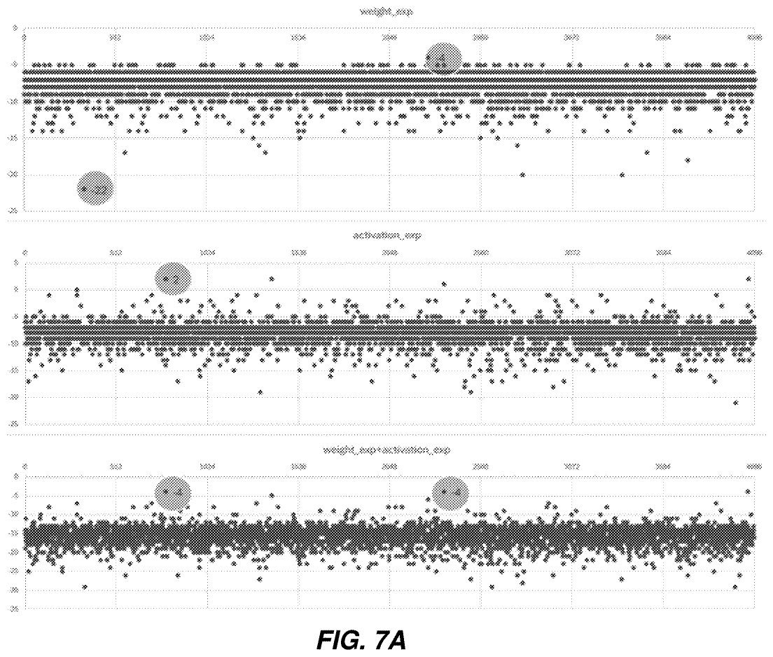

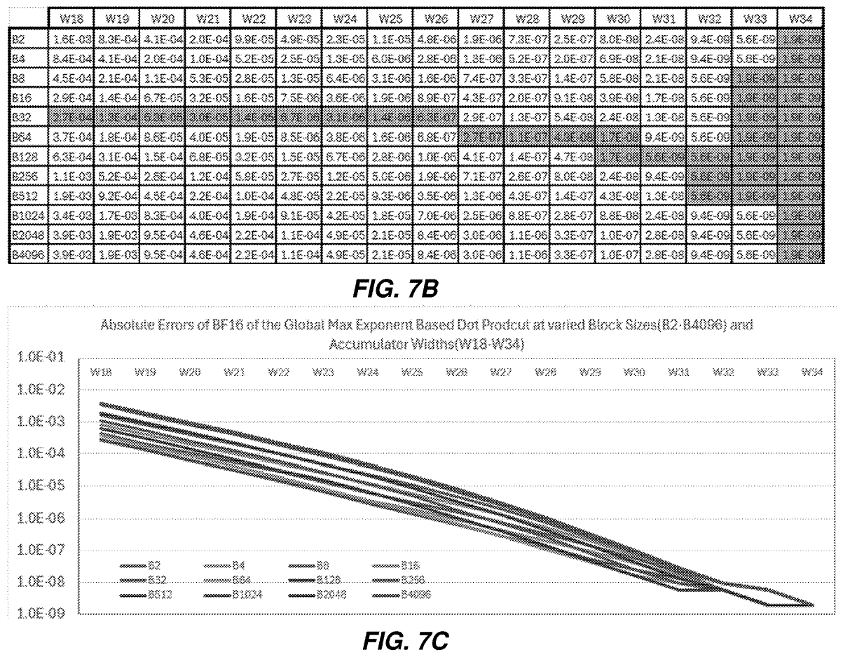

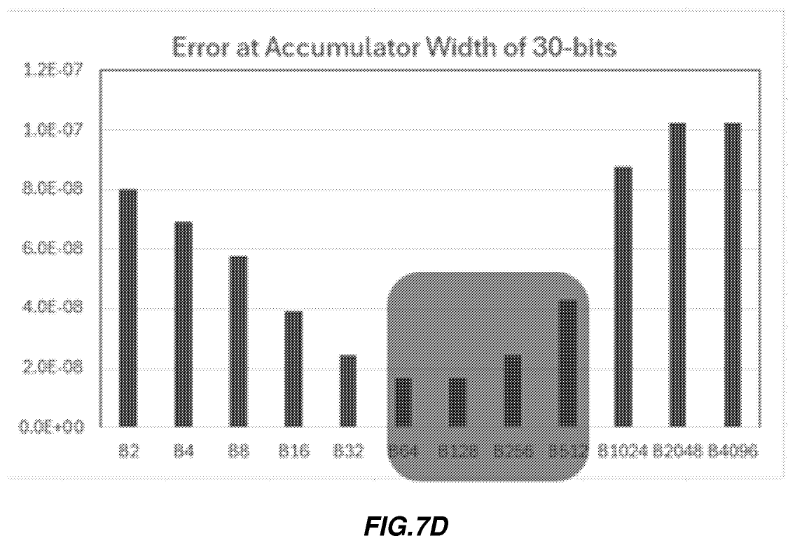

FIGS. 7A-D present empirical validation data, error analyses, and precision sweep results used to benchmark the performance of the global maximum exponent-based architecture against conventional baselines.

FIG. 7A illustrates a series of scatter plots charting the exponent range distributions extracted from a real-world AI workload, specifically the LLaMA-3 8B Instruct model. The top plot maps the weight exponents (weight_exp), highlighting a maximum weight exponent observed at −4 and a minimum around −22. The middle plot maps the activation exponents (activation_exp), identifying a maximum activation exponent of 2. The bottom plot maps the summed exponent distribution (weight_exp+activation_exp), revealing that the maximum critical exponent observed across all data points is −4. This statistical analysis proves that estimating the maximum exponent requires only minimal extra bits (e.g., 2 to 5 extra bits) in the accumulator to maintain strict precision equivalence with conventional architectures.

FIG. 7B presents a tabular data set detailing the absolute computation error of the global maximum exponent-based dot product across varied block sizes and accumulator widths. The rows represent distinct processing Block Sizes, scaling logarithmically from B2 to B4096. The columns represent the hardware Accumulator Widths, scaling incrementally from W18 to W34.

The numerical data demonstrates a strict inverse relationship between computation error and accumulator width. The highlighted cells indicate the optimal hardware configurations where absolute error reaches a minimum threshold (e.g., 1.9E-09).

FIG. 7C provides a visual representation of the tabular data from FIG. 7B, plotting the absolute errors of BF16 computations. The X-axis tracks the scaling Accumulator Widths (W18 through W34), while the Y-axis tracks the corresponding Absolute Errors logarithmically (from 1.0E-01 down to 1.0E-09).

The individual plotted lines represent the varied Block Sizes (B2 through B4096). The downward trajectory of all plotted lines visually proves that scaling the accumulator width effectively mitigates any precision loss introduced by the global exponent estimation methodology.

FIG. 7D isolates a specific precision benchmark, utilizing a bar chart to display the absolute computation error strictly at an accumulator width of 30 bits across all tested block sizes. The chart highlights a distinct operational “sweet spot” for mid-range block sizing. As indicated by the highlighted region, block sizes of B64, B128, B256, and B512 yield the lowest relative absolute error at this accumulator width before the error rate begins to rise again for larger block sizes (e.g., B1024 through B4096).

In conclusion, the disclosed global maximum exponent-based matrix multiplication engine represents a fundamental architectural shift from conventional block-normalized floating-point processing, offering profound advantages for Large Language Model (LLM) training and inference. By replacing repetitive, localized block-wise exponent comparisons with a precomputed global maximum exponent derived from independently estimated activation and weight maximums, the invention significantly reduces the mathematical complexity of exponent alignment from O(n³) to O(n²) operations. Furthermore, by establishing a uniform exponent baseline across multiple Multiply-Accumulate (MAC) arrays, the architecture natively aggregates intermediate block sums and completely eliminates the need for frequent, resource-intensive normalizations, requiring only a single normalization to FP32 triggered by accumulator overflow. When combined with modestly widened accumulation datapaths to preserve mathematical precision, this streamlined approach yields a highly efficient hardware solution that reduces the physical silicon footprint—by up to 17% over commercial baselines—and drastically lowers overall power consumption without sacrificing the critical accuracy required for state-of-the-art AI processing.

### EXAMPLES

The following are example implementations of different embodiments of the invention.

Example 1. An apparatus, comprising: one or more memories to store a plurality of activation data elements and a plurality of weight data elements; and accelerator circuitry coupled to the one or more memories, the accelerator circuitry comprising: precomputation circuitry to determine a global maximum exponent based on a maximum activation exponent of the plurality of activation data elements and a maximum weight exponent of the plurality of weight data elements; multiply-accumulate (MAC) circuitry to: align mantissa products of the activation data elements and the weight data elements based on the global maximum exponent to produce aligned mantissa products; and accumulate the aligned mantissa products to generate an output result.

Example 2. The apparatus of Example 1, wherein determining the global maximum exponent comprises calculating a sum of the maximum activation exponent and the maximum weight exponent.

Example 3. The apparatus of Example 1, wherein the MAC circuitry comprises a plurality of MAC circuit blocks, each MAC circuit block comprising: multiplication circuitry to generate a corresponding subset of the mantissa products with a corresponding subset of the activation data elements and a corresponding subset of the weight data elements; wherein the precomputation circuitry is to determine a corresponding plurality of exponent difference values by subtracting corresponding individual activation exponents from the global maximum exponent and is to provide a corresponding subset of the plurality of exponent difference values to each MAC circuit block of the plurality of MAC circuit blocks.

Example 4. The apparatus of Example 3, wherein each MAC circuit block is to determine an individual shift value for a respective pair of activation and weight data elements of the corresponding subsets of activation data elements and weight data elements by subtracting an individual weight exponent from a respective precomputed exponent difference value of the corresponding subset.

Example 5. The apparatus of Example 4, wherein to align the mantissa products, each MAC circuit block is to execute a corresponding right-shift operation on the corresponding subset of mantissa products based on the individual shift value.

Example 6. The apparatus of Example 3, wherein each MAC circuit block is to reuse the one of the corresponding plurality of exponent difference values across a corresponding plurality of computations involving the subset of the activation data elements from a row of an activation matrix to compute a corresponding subset of output data elements of an output matrix.

Example 7. The apparatus of Example 1, wherein to accumulate the aligned mantissa products to generate an output result comprises to natively sum intermediate block sums without executing further relative exponent shifting operations.

Example 8. The apparatus of Example 1, wherein the MAC circuitry comprises accumulation circuitry to accumulate the aligned mantissa products, the accumulation circuitry comprising an extended bit-width configured to preserve precision of bits shifted during alignment.

Example 9. The apparatus of Example 1, wherein the MAC circuitry comprises normalization circuitry to perform a single normalization operation on the accumulated aligned mantissa products to generate the output result comprising a floating-point output.

Example 10. The apparatus of Example 9, wherein the normalization circuitry is to perform the single normalization operation based on detecting an overflow condition during the accumulation.

Example 11. A machine-readable medium having program code stored thereon which, when executed by one or more processors, is to cause the one or more processors to perform operations, comprising: receiving a plurality of activation data elements and a plurality of weight data elements; determining a global maximum exponent based on a maximum activation exponent of the plurality of activation data elements and a maximum weight exponent of the plurality of weight data elements; aligning mantissa products of the activation data elements and the weight data elements based on the global maximum exponent; and accumulating the aligned mantissa products to generate an output result.

Example 12. The machine-readable medium of Example 11, wherein determining the global maximum exponent comprises calculating a sum of the maximum activation exponent and the maximum weight exponent.

Example 13. The machine-readable medium of Example 11, further comprising program code to cause the one or more processors to perform the operations of: precomputing a plurality of exponent difference values by subtracting respective individual activation exponents from the global maximum exponent.

Example 14. The machine-readable medium of Example 13, further comprising program code to cause the one or more processors to perform the operations of: calculating an individual shift value for a respective pair of activation and weight data elements by subtracting an individual weight exponent from a corresponding precomputed exponent difference value of the plurality of exponent difference values.

Example 15. The machine-readable medium of Example 14, wherein aligning the mantissa products comprises executing a right-shift operation on the mantissa products based on the individual shift value.

Example 16. The machine-readable medium of Example 13, further comprising program code to cause the one or more processors to perform the operations of: reusing the precomputed plurality of exponent difference values across a plurality of computations involving a row of an activation matrix to compute multiple elements of an output matrix.

Example 17. The machine-readable medium of Example 11, wherein accumulating the aligned mantissa products comprises natively summing intermediate block sums without executing further relative exponent shifting operations.

Example 18. The machine-readable medium of Example 11, wherein accumulating the aligned mantissa products is performed utilizing an accumulator comprising an extended bit-width configured to preserve precision of bits shifted during alignment.

Example 19. The machine-readable medium of Example 11, further comprising program code to cause the one or more processors to perform the operations of: executing a single normalization operation on the accumulated aligned mantissa products to generate a high-precision floating-point output.

Example 20. The machine-readable medium of Example 19, wherein the single normalization operation is triggered based on detecting an overflow condition during the accumulation of the aligned mantissa products.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. An apparatus, comprising:
one or more memories to store a plurality of activation data elements and a plurality of weight data elements; and
accelerator circuitry coupled to the one or more memories, the accelerator circuitry comprising:
precomputation circuitry to determine a global maximum exponent based on a maximum activation exponent of the plurality of activation data elements and a maximum weight exponent of the plurality of weight data elements;
multiply-accumulate (MAC) circuitry comprising a plurality of MAC circuit blocks to:
align mantissa products of the activation data elements and the weight data elements across the plurality of MAC circuit blocks based on the global maximum exponent to produce aligned mantissa products; and
accumulate the aligned mantissa products to generate an output result.

2. The apparatus of claim 1, wherein determining the global maximum exponent comprises calculating a sum of the maximum activation exponent and the maximum weight exponent.

3. The apparatus of claim 1, each MAC circuit block comprising:
multiplication circuitry to generate a corresponding subset of the mantissa products with a corresponding subset of the activation data elements and a corresponding subset of the weight data elements;
wherein the precomputation circuitry is to determine a corresponding plurality of exponent difference values by subtracting corresponding individual activation exponents from the global maximum exponent and is to provide a corresponding subset of the plurality of exponent difference values to each MAC circuit block of the plurality of MAC circuit blocks.

4. The apparatus of claim 3, wherein each MAC circuit block is to determine an individual shift value for a respective pair of activation and weight data elements of the corresponding subsets of activation data elements and weight data elements by subtracting an individual weight exponent from a respective precomputed exponent difference value of the corresponding subset.

5. The apparatus of claim 4, wherein to align the mantissa products, each MAC circuit block is to execute a corresponding right-shift operation on the corresponding subset of mantissa products based on the individual shift value.

6. The apparatus of claim 3, wherein each MAC circuit block is to reuse the one of the corresponding plurality of exponent difference values across a corresponding plurality of computations involving the subset of the activation data elements from a row of an activation matrix to compute a corresponding subset of output data elements of an output matrix.

7. The apparatus of claim 1, wherein to accumulate the aligned mantissa products to generate an output result comprises to sum intermediate block sums without executing further relative exponent shifting operations.

8. The apparatus of claim 1, wherein the MAC circuitry comprises accumulation circuitry to accumulate the aligned mantissa products, the accumulation circuitry comprising an extended bit-width configured to preserve precision of bits shifted during alignment.

9. The apparatus of claim 1, wherein the MAC circuitry comprises normalization circuitry to perform a single normalization operation on the accumulated aligned mantissa products to generate the output result comprising a floating-point output.

10. The apparatus of claim 9, wherein the normalization circuitry is to perform the single normalization operation based on detecting an overflow condition during the accumulation.

11. A machine-readable medium having program code stored thereon which, when executed by one or more processors, is to cause the one or more processors to perform operations, comprising:
receiving a plurality of activation data elements and a plurality of weight data elements;
determining, by precomputation circuitry, a global maximum exponent based on a maximum activation exponent of the plurality of activation data elements and a maximum weight exponent of the plurality of weight data elements;
aligning mantissa products of the activation data elements and the weight data elements based on the global maximum exponent, the mantissa products and the weight data to be aligned across a plurality of multiply-accumulate (MAC) circuit blocks of a plurality of MAC circuit blocks; and
accumulating, by the plurality of MAC circuit blocks, the aligned mantissa products to generate an output result.

12. The machine-readable medium of claim 11, wherein determining the global maximum exponent comprises calculating a sum of the maximum activation exponent and the maximum weight exponent.

13. The machine-readable medium of claim 11, further comprising program code to cause the one or more processors to perform the operations of: precomputing a plurality of exponent difference values by subtracting respective individual activation exponents from the global maximum exponent.

14. The machine-readable medium of claim 13, further comprising program code to cause the one or more processors to perform the operations of: calculating an individual shift value for a respective pair of activation and weight data elements by subtracting an individual weight exponent from a corresponding precomputed exponent difference value of the plurality of exponent difference values.

15. The machine-readable medium of claim 14, wherein aligning the mantissa products comprises executing a right-shift operation on the mantissa products based on the individual shift value.

16. The machine-readable medium of claim 13, further comprising program code to cause the one or more processors to perform the operations of: reusing the precomputed plurality of exponent difference values across a plurality of computations involving a row of an activation matrix to compute multiple elements of an output matrix.

17. The machine-readable medium of claim 11, wherein accumulating the aligned mantissa products comprises natively summing intermediate block sums without executing further relative exponent shifting operations.

18. The machine-readable medium of claim 11, wherein accumulating the aligned mantissa products is performed utilizing an accumulator comprising an extended bit-width configured to preserve precision of bits shifted during alignment.

19. The machine-readable medium of claim 11, further comprising program code to cause the one or more processors to perform the operations of: executing a single normalization operation on the accumulated aligned mantissa products to generate a high-precision floating-point output.

20. The machine-readable medium of claim 19, wherein the single normalization operation is triggered based on detecting an overflow condition during the accumulation of the aligned mantissa products.
